(19) United States
(12) Patent Application Publication
(10) Pub. No.: US 2010/0066200 A1
(43) Pub. Date: Mar. 18, 2010

(54) CARBON BRUSH HOLDER

(75) Inventors: Meng-Chiu YU, Taichung (TW); Su-Chen LIAO, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: TAIWAN LONG HAWN ENTERPRISE CO., TAICHUNG CITY (TW)

(21) Appl. No.: 12/247,486

(22) Filed: Oct. 8, 2008

(30) Foreign Application Priority Data
Sep. 16, 2008 (TW) 97135522

(51) Int. Cl. H01R 39/40

(52) U.S. Cl. 310/239

(57) ABSTRACT

A carbon brush holder includes an insulating housing, a conductive base fixed to the insulating housing, and an electrical connector connected to the conductive base by a rivet. The conductive base is provided with a slot under a roll portion of the rivet to protect the roll portion from deformation.

### BACKGROUND OF THE INVENTION

1. Field of the Invention

The present invention relates to a motor and more particularly, to a carbon brush holder.

2. Description of the Related Art

As shown in FIG. 1 and FIG. 2, a conventional carbon brush holder 1 includes a conductive base 2, an insulating housing 3, and an electrical connector 4. Typically, the housing 3 is a barrel made of Bakelite or other insulating materials, and the conductive base 2 is made of copper. The conductive base 2 is inserted into the housing 3 and fixed therein. The electrical connector 4 is fixed to the conductive base 2 by a rivet 5.

As shown in FIG. 3, the rivet 5 passes through holes on the electrical connector 4 and the conductive base 2 and is pressed to form a roll portion 5a to fix the electrical connector 4 on the conductive base 2. A vibration caused by the motor or in the task of replacement of carbon brush (not shown) will incline the electrical connector 4 and deform the roll portion 5a as shown FIG. 4. It will generate a gap d between the deformed roll portion 5a and the conductive base 2, and this gap d will increase the conduction resistance and cause arc discharges.

### SUMMARY OF THE INVENTION

The primary objective of the present invention is to provide a carbon brush holder, which may fix the problem of the rivet deformed and loosing.

To achieve this and other objects of the present invention, a carbon brush holder includes an insulating housing, a conductive base fixed to the insulating housing, and an electrical connector connected to the conductive base by a rivet. The conductive base is provided with a slot under a roll portion of the rivet to protect the roll portion from deformation.

### BRIEF DESCRIPTION OF THE DRAWING

FIG. 1 is a perspective view of the conventional carbon brush holder;

FIG. 2 is an exploded view of the conventional carbon brush holder;

FIG. 3, FIG. 4, and FIG. 5 are sectional views of the conventional carbon brush holder, showing the rivet being deformed;

FIG. 6 is a perspective view of a preferred embodiment of the present invention;

FIG. 7 is an exploded view of the preferred embodiment of the present invention; and

FIG. 8 and FIG. 9 are sectional views of the preferred embodiment of the present invention, showing how the slot protect the roll portion of the rivet.

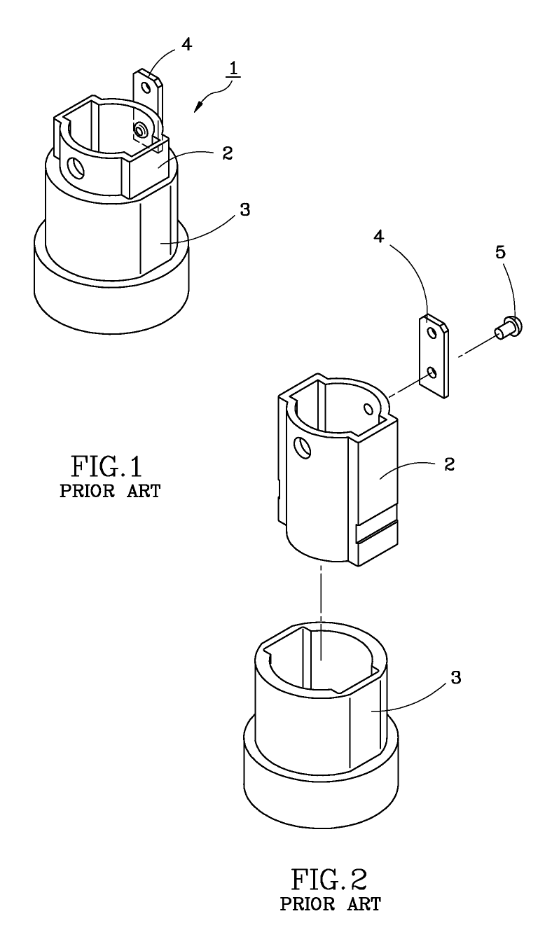

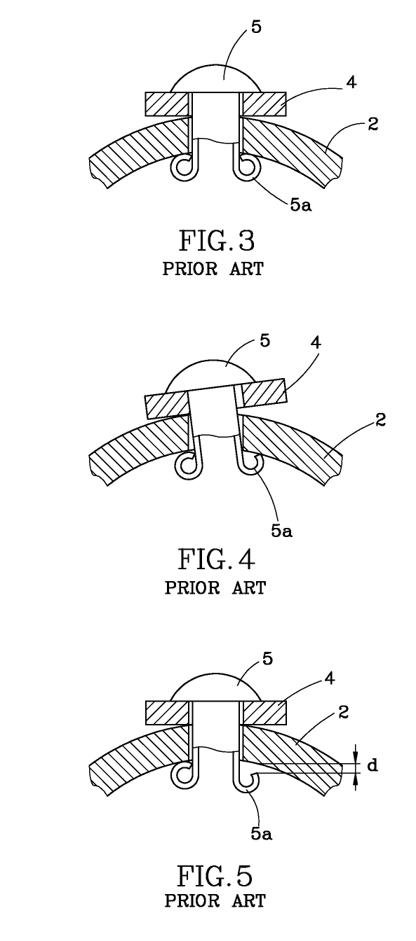

### DETAILED DESCRIPTION OF THE INVENTION

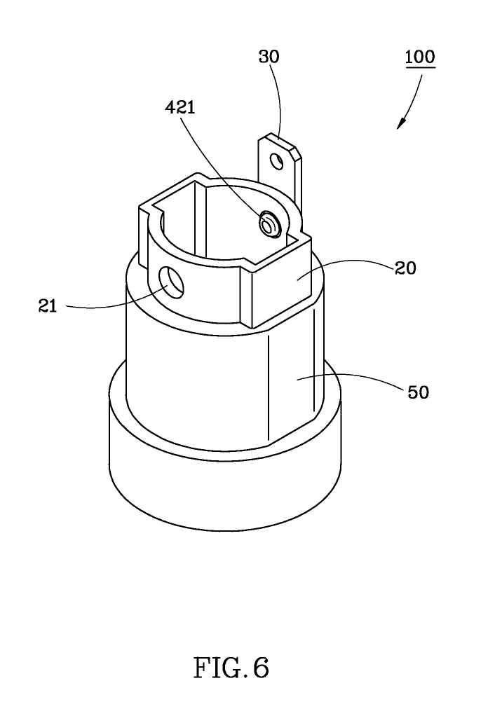

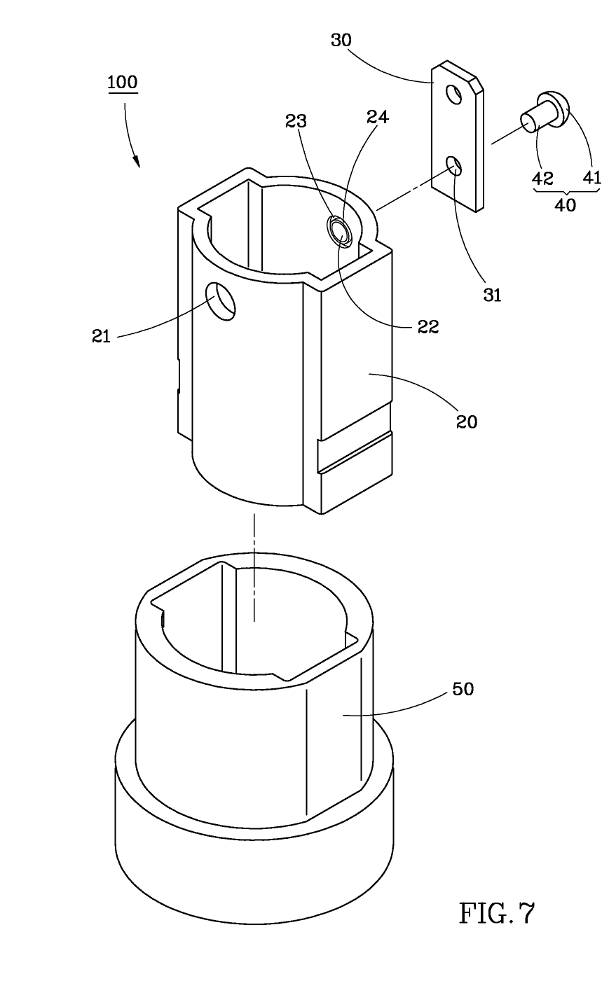

Referring to FIG. 6 and FIG. 7, a carbon brush holder 100 of the preferred embodiment of the present invention includes a conductive base 20, an electrical connector 30, a rivet 40, and an insulating housing 20.

The insulating housing 50 is a barrel made of Bakelite or other insulating materials, and the conductive base 20 is made of copper or other conductive materials. The conductive base 20 has an end inserted into the insulating housing 50 and fixed therein. The conductive base 20 has a portion left out of the insulating housing 50, on which a through hole 21 and a connecting hole 22 are provided. The electrical connector 30 is provided with a connecting hole 31. The rivet 40 has a head 41 and a post 42. The post 42 of the rivet 40 is inserted into the connecting hole 31 of the electrical connector 30 and the connecting hole 22 of the conductive base 20. A riveter (not shown) is inserted into the through hole 21 to press the post 42 of the rivet 40 that the rivet 40 will have a roll portion 422.

Above elements are as same as the conventional carbon brush holder, and the character of the present invention is described in following:

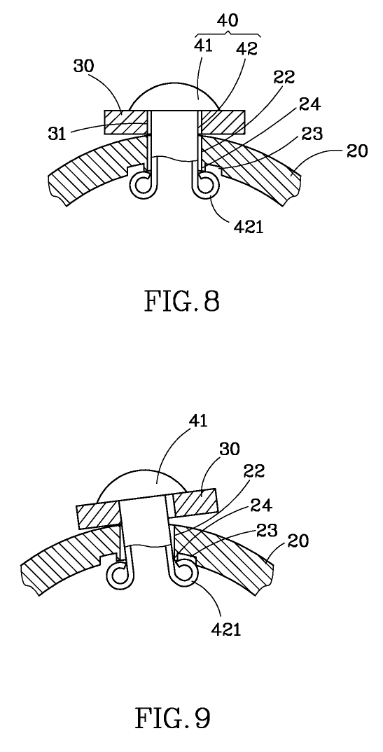

On an inner side of the conductive base 20 is provided with an annular slot 23 surrounding the connecting hole 22, and an annular protrusion 24 is formed between the slot 23 and the connecting hole 22. As FIG. 8, the slot 23 is under the roll portion 422 of the rivet 40, and a free end of the roll portion 422 touches the protrusion 24.

As shown in FIG. 9, when the electrical connector 40 is inclined by an external force, the roll portion 422 of the rivet 40 may enter the slot 23 to prevent the roll portion 422 form being deformed. The protrusion 24 keeps touching the free end of the roll portion 422 of the rivet 40 that may prevent the roll portion 422 form being deformed also.

In conclusion, no mater the motor runs for a long time, or the carbon brush is replaced, the rivet will not be deformed and firmly connect the electrical connector 30 and the conductive base 20 together. The present invention will not have a deformed and loosing rivet that will not increase the conduction resistance and generate arc discharge.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A carbon brush holder, comprising:
an insulating housing;
a conductive base, which is fixed to said insulating housing, having a connecting hole and a slot adjacent to said connecting hole;
an electrical connector having a connecting hole; and
a rivet, which has a head and a post, having said post inserted into said connecting hole of said electrical connector and said connecting hole of said conductive base to be pressed to form a roll portion.

2. The carbon brush holder as claimed in claim 1, wherein said slot is an annular slot surrounding said connecting hole.

3. The carbon brush holder as claimed in claim 2, wherein said conductive base has a protrusion between said connecting hole and said slot.

4. The carbon brush holder as claimed in claim 3, wherein said slot touches a free end of said roll portion of said rivet.

5. The carbon brush holder as claimed in claim 1, wherein said conductive base has a protrusion between said connecting hole and said slot.

6. The carbon brush holder as claimed in claim 5, wherein said slot touches a free end of said roll portion of said rivet.

7. The carbon brush holder 1 as claimed in claim 1, wherein said slot is under said roll portion of said rivet.

8. The carbon brush holder 1 as claimed in claim 2, wherein said slot is under said roll portion of said rivet.

9. The carbon brush holder 1 as claimed in claim 1, wherein said roll portion of said rivet enters said slot when said rivet is inclined.

10. The carbon brush holder 1 as claimed in claim 2, wherein said roll portion of said rivet enters said slot when said rivet is inclined.
